(19) United States
(12) Patent Application Publication
(10) Pub. No.: US 2013/0334755 A1
(43) Pub. Date: Dec. 19, 2013

(54) Hold Down and Masking Apparatus for Part Processing

(71) Applicant: ENGINEERED ABRASIVES, INC., Alsip, IL (US)

(72) Inventor: Michael J. Wern, Alsip, IL (US)

(73) Assignee: ENGINEERED ABRASIVES, INC., Alsip, IL (US)

(21) Appl. No.: 13/798,689

(22) Filed: Mar. 13, 2013

Related U.S. Application Data
(60) Provisional application No. 61/658,965, filed on Jun. 13, 2012.

(51) Int. Cl. B25B 5/06

(52) U.S. Cl. CPC B25B 5/06
USPC 269/254 CS

(57) ABSTRACT

The present disclosure includes a part hold-down assembly for retaining a part. The part hold-down assembly includes an upper collar, a lower collar and a resiliant biasing member, in one embodiment in the form of a coil spring, retained between the upper and lower collar. The upper collar has a first end, the first end having an annular ledge. The lower collar has a second end, the second end having an annular ledge. The resiliant biasing member includes a first end and a second end, the first coil end configured to engage with the annular ledge of the upper collar and the second coil end configure to engage with the second annular ledge of the lower collar.

### CROSS-REFERENCE

This application claims the benefit of U.S. Provisional Patent Application No. 61/658,965, filed Jun. 13, 2012 and entitled “Hold Down and Masking Apparatus for Peening Operation,” the entire disclosure of which is incorporated herein.

### BACKGROUND

The subject matter disclosed herein relates to a part hold-down assembly, and more particularly, a part hold-down assembly for a part processing apparatus. More particularly, the present invention includes a system, method, and apparatus for use in holding and fixturing parts in an automatic apparatus for processing parts. The hold-down device is similar to the device as shown in U.S. Pat. No. 5,272,897, which is hereby incorporated by reference.

A hold-down apparatus may be used in an automatic part processing apparatus for fully automatically processing a part or work piece by methods such as shot peening and the like. Hold-down devices as shown in U.S. Pat. No. 5,272,897 use resiliant biasing members secured to corresponding collars by welds to hold parts or work pieces in the apparatus. As a result of repetitive use, the resiliant biasing member tends to wear on the collar and/or welds. Over time, the welds could fracture or break, resulting in potential misalignment of the resiliant biasing member against the collar surface. In previous hold-down devices, the resiliant biasing member attaches to a planar surface of the corresponding collar, and the end of the resiliant biasing member can tend to “walk” or slip off the collar if it became dislodged or the weld breaks. This can cause misalignment or axially skewed angling of the hold-down device. The present invention is an improvement on the prior art with these potential issues.

This background information is provided to provide some information believed by the applicant to be of possible relevance to the present disclosure. No admission is intended, nor should such admission be inferred or construed, that any of the preceding information constitutes prior art against the present disclosure. Other aims, objects, advantages and features of the disclosure will become more apparent upon reading of the following non-restrictive description of specific embodiments thereof, given by way of example only with reference to the accompanying drawings.

The present disclosure provides for collars which help align and secure the resiliant biasing member without attachment thereto (via welds or other methods). The collars also facilitate controlled use of the resiliant biasing member relative to the apparatus. Thus, the present disclose provides for an improvement on an automatic apparatus for processing parts and a part hold-down apparatus for use with the apparatus. The hold-down apparatus includes an improved assembly, including a compressible resiliant biasing member and a pair of corresponding collars positioned at opposite ends of the resiliant biasing member.

According to one embodiment, a part hold-down assembly is configured to retain a part. The part hold-down assembly includes an upper collar, a lower collar and a coil resiliant biasing member retained between the upper and lower collar. The upper collar has a first end, the first end having an annular ledge. The lower collar has a second end, the second end having an annular ledge. The coil resiliant biasing member includes a first coil end and a second coil end, the first coil end configured to engage with the annular ledge of the upper collar and the second coil end configure to engage with the second annular ledge of the lower collar.

According to another embodiment, an apparatus is configured to process a part. The apparatus includes a part-hold down assembly for retaining the part in the apparatus during processing. The apparatus also includes an upper shaft configured to retain the part hold-down assembly in the apparatus and a support configured to retain the part in the apparatus. The part hold-down assembly includes an upper collar, a lower collar, and a coil resiliant biasing member retained therebetween. The upper and the lower collars include an annular ledge formed in corresponding surfaces to retain a portion of a corresponding end of the coil resiliant biasing member therein, the corresponding ends of the coil resiliant biasing member being attached to the corresponding ends of the upper and lower collars with the ends of the coil resiliant biasing member being retained in the corresponding annular ledges.

These and other advantages and features will become more apparent from the following description taken in conjunction with the drawings.

### BRIEF DESCRIPTION OF THE DRAWINGS

The present disclosure will be described hereafter with reference to the attached drawings which are given as a non-limiting example only, in which:

FIG. 1 is a perspective view of an automatic part processing apparatus for processing the part by a method such as peening, with a portion of the apparatus broken away to reveal a turntable and a set of lower spindles, and having a part hold-down assembly constructed according to the teachings of the present disclosure;

FIG. 2 is an exploded elevational view of the part hold-down assembly of the present invention including an assembly of collars and a resiliant biasing member, showin by way of illustration and not limitation, as a coil spring, disclosed herein, the collars including annular recesses for cooperative engagement with flattened ends of the spring coil body, each of the first and second collars providing an annular recess;

FIG. 3 is an exploded perspective view of the resiliant biasing member and collar assembly of FIG. 2, showing in detail the annular ledge located on a collar that corresponds to one end of the spring coil body, and showing the collars are detachable from the spring coil body;

FIG. 4 is a cross-sectional view taken along the line 4-4 of FIG. 2, showing the resiliant biasing member and collar assembly;

FIG. 5 is an enlarged, cross-sectional, elevational view of the resiliant biasing member and collar assembly as shown in FIG. 2, showing the circumferential width of the spring coil body is slightly less than the circumferential width of the annular ledge of the collars such that the flattened ends of the spring coil body fit within the recess created by the annular ledges.

FIG. 6 is a side elevation view of an alternative embodiment of the resiliant biasing member and collar assembly, showing the flattened ends of the spring coil body can be maintained within the annular ledge by means of one or more straps that extend around the entire resiliant biasing member and collar assembly, or for example, otherwise hold the collar and spring coil body together; and

FIG. 7 is a side elevation view of another alternative embodiment of the resiliant biasing member and collar assembly, showing the flattened ends of the spring coil body can be maintained within the annular ledge by means of a sleeve surrounding the spring.

The exemplification set out herein illustrates embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure. The disclosure is not limited in its application to the details of structure, function, construction, or the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of various phrases and terms is meant to encompass the items or functions identified and equivalents thereof as well as additional items or functions. Unless limited otherwise, various phrases, terms, and variations thereof herein are used broadly and encompass all variations of such phrases and terms. Furthermore, and as described in subsequent paragraphs, the specific configurations illustrated in the drawings are intended to exemplify embodiments of the disclosure. However, other alternative structures, functions, and configurations are possible which are considered to be within the teachings of the present disclosure. Furthermore, unless otherwise indicated, the term “or” is to be considered inclusive.

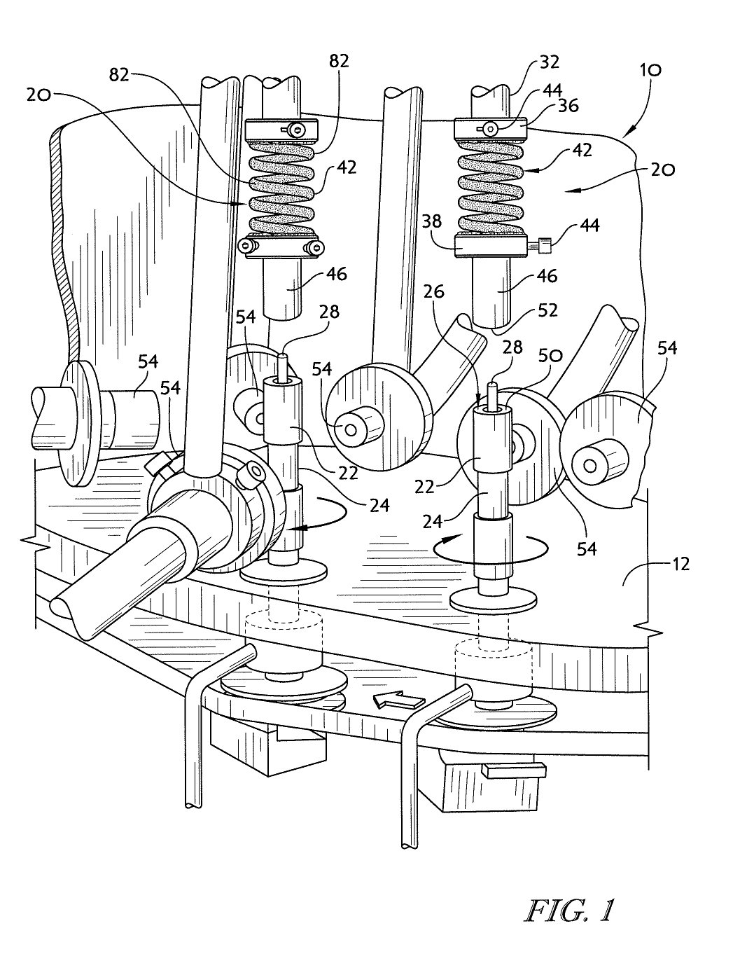

As shown in FIG. 1, a processing assembly 10 of a larger parts-processing apparatus is shown. The overall parts processing apparatus is similar to that as shown and described in U.S. Pat. No. 5,272,897. While the basic operation of this parts processing apparatus will be described hereinbelow, the primary focus of the present application will be on the structures and functions associated with a part hold-down assembly or apparatus 20. During the use of the processing apparatus, a part 22 can be fixtured on a support 24, as illustrated in FIG. 1. The part 22 may be of varying forms, but may typically be a hollow component, at least for the present configuration of the apparatus, having a generally cylindrical cavity 26 extending therethrough. An example of such a part 22 might include an automotive gear component. A shaft or pin 28 extends from the support 24 through the cavity 26 of the part 22 to help provide axial alignment of the components.

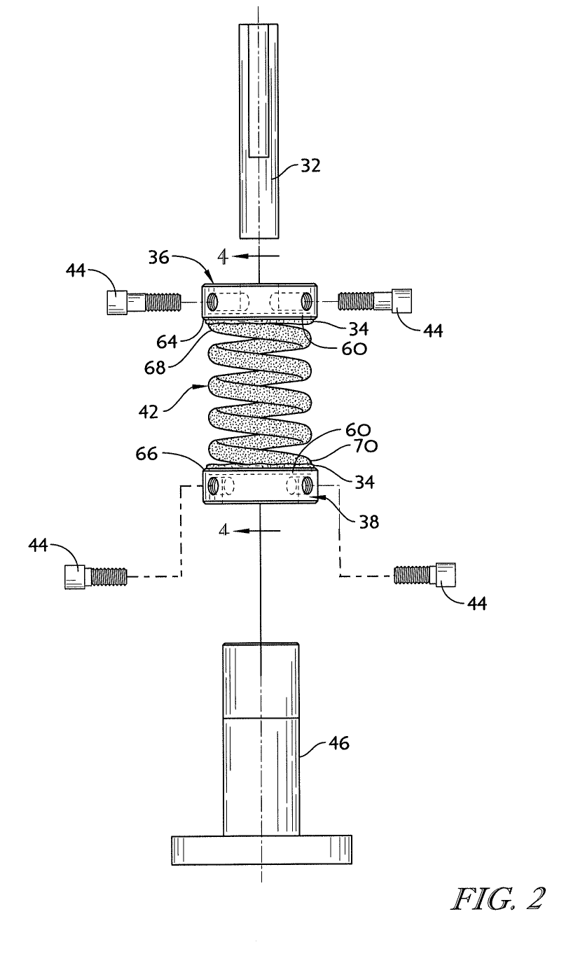

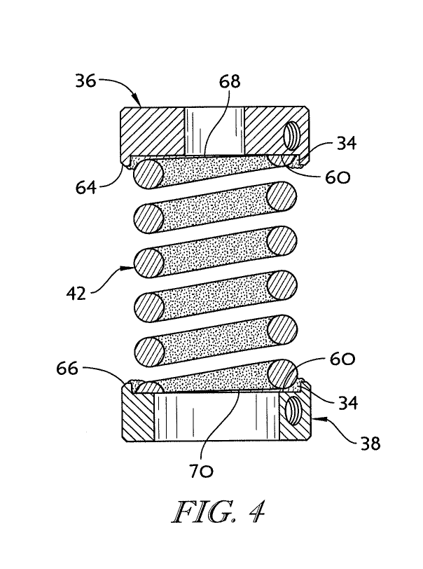

As illustrated in FIGS. 2-4, the part hold-down assembly 20 generally includes an upper collar 36, a lower collar 38, and a resiliant biasing member 42. The resilient biasing member 42 is shown by way of illustration and not for limitation as a coil spring 42 or other compressive structure. Other forms of a resilient biasing member 42 may be used to achieve the claimed invention and every other form of such member is incorporated within the scope of this disclosure to provide the structures and functions of the invention. The resilient biasing member 42 may be made of an suitable material, include metals and plastics.

The hold-down assembly 20 is carried on an upper portion of the processing assembly 10 with a shaft 32 providing a point of contact. The shaft 32 is coupled to the upper collar 36. The lower collar 38 is configured to engage with the part 22 to be processed. The resiliant biasing member 42 is retained between the upper and lower collars 36, 38. One or more set screws 44 can be provided on the upper collar 36 for attaching the upper collar 36 to the shaft 32. Similarly, an end or masking portion 46 can be attached to the corresponding lower collar 38 by use of a corresponding set screw 44, as illustrated in FIG. 2.

The masking portion 46 is used to abut against a corresponding surface 50 of the part 22 in order to block or mask processing of that surface 50 of the part 22. Specifically, masking occurs by engaging a leading end surface 52 of the masking portion 46 with the corresponding surface 50 of the part 22. With the surfaces 50, 52 in face-to-face, contact the surface 50 of the part 22 is shielded or masked from the processing steps. For example, one type of process used with such processing assembly 10 may be peening. As shown in FIG. 1, a series of peening nozzles 54 may be directed in the general vicinity and direction of parts 22 carried on the processing assembly 10. Since the surface 50 of part 22 is shielded by the leading end surface 52, the peening material exiting the nozzles 54 cannot act on the surface 50 during a peening process.

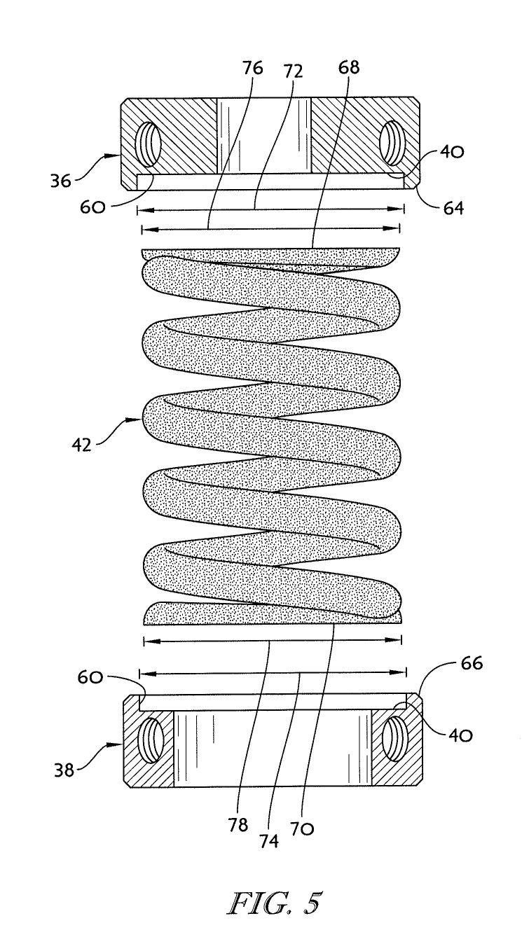

With reference to FIGS. 1-5, the upper and lower collars 36, 38 and the resiliant biasing member 42 are assembled together for attachment to the upper shaft 32 and the lower masking portion 46.

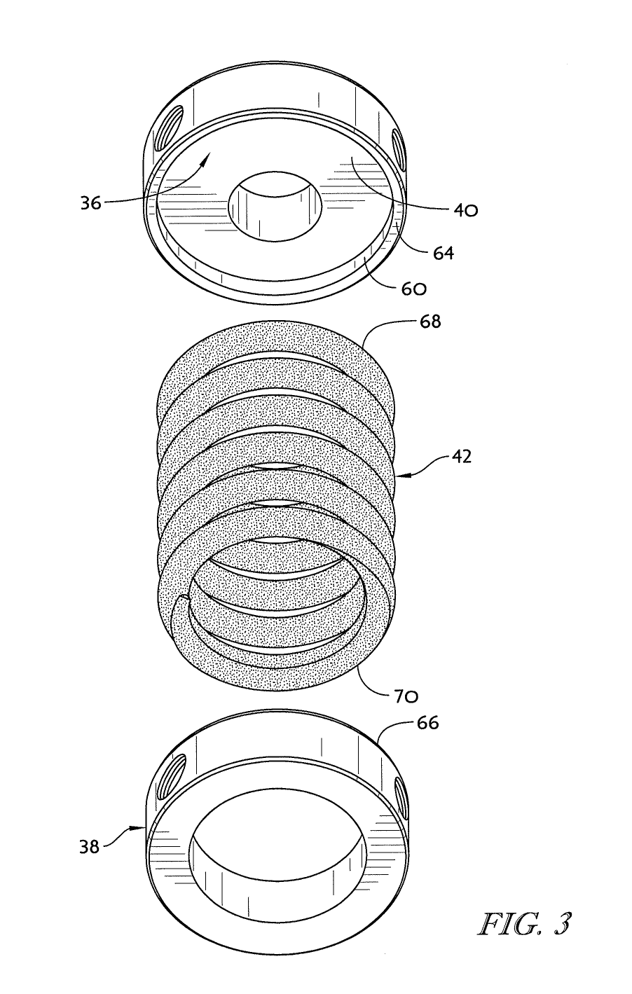

The resiliant biasing member 42 of the hold-down assembly 20 may be made by various methods to achieve desired strength and resiliant biasing member force within the hold-down assembly 20. The resiliant biasing member 42 may, for instance, be subjected to a processing step as well, such as peening, to provide improved strength or stability characteristics. As illustrated in FIGS. 3-5, the resiliant biasing member 42 includes coil ends 68, 70 that are configured to maximize engagement with contact surfaces 40 of upper and lower collars 36, 38. In illustrative embodiments, ends 68, 70 may be flattened to maximize engagement with the upper and lower collars 36, 38. The resiliant biasing member 42 may be specifically sized to engage with upper and lower collars 36, 38.

While not described herein, reference is made to the incorporated patent, U.S. Pat. No. 5,272,897 with regard to the operation of the overall part processing apparatus. The processing assembly 10 receives a part 22 mounted on the support 24, which is then processed in an automated manner. The processing includes automated fixturing of the part hold-down assembly 20 against the part 22, rotation of the part 22 relative to the nozzles 54 and movement of the part 22 on a turntable 12 through a processing path. While the process itself is not the subject of the present application, the operation of the process is important because it highlights the need for the structures and functions of the part hold-down assembly 20 as disclosed herein.

As noted, the part hold-down assembly 20 includes specifically designed upper and lower collars 36, 38. Previous part processing apparatuses did not include any structure for retaining a resiliant biasing member relative to a collar. As shown more explicitly in FIGS. 3-5, a corresponding annular ledge 60 is formed in corresponding coil-engaging ends 64, 66 of each collar 36, 38. The contact surfaces 40 of each collar 36, 38 are radially inward of the ledge 60. In illustrative embodiments, the ledge 60 extends from the ends 64, 66 to the contact surface 40 of each collar 36, 38. Other embodiments are also envisioned.

The annual ledge 60 of the collars 36, 38 helps solve an important need in the present invention and processing assembly 10. The ledge 60 allows the resiliant biasing member 42 to be attached to the upper and lower collars 36, 38 in a variety of ways, all which are structurally equivalent in the broadest sense. Additionally, the use of the annular ledge 60 and the attachment of the resiliant biasing member 42 relative to the collars 36, 38 should be broadly interpreted to include all of the presently known and hereafter discovered structures to achieve this function. The annular ledge 60 is important since it provides a fixturing and locating structure for a positive engagement between the coil ends 68, 70 of the resiliant biasing member 42 and the collars 36, 38. While flattened coil ends 68, 70 are shown, the coil ends 68, 70 may not be machined or formed as flattened ends but may be formed as non-flattened ends. Either way, the coil ends 68, 70 of the resiliant biasing member 42 can be retained in the annular ledge 60 the collars 36, 38.

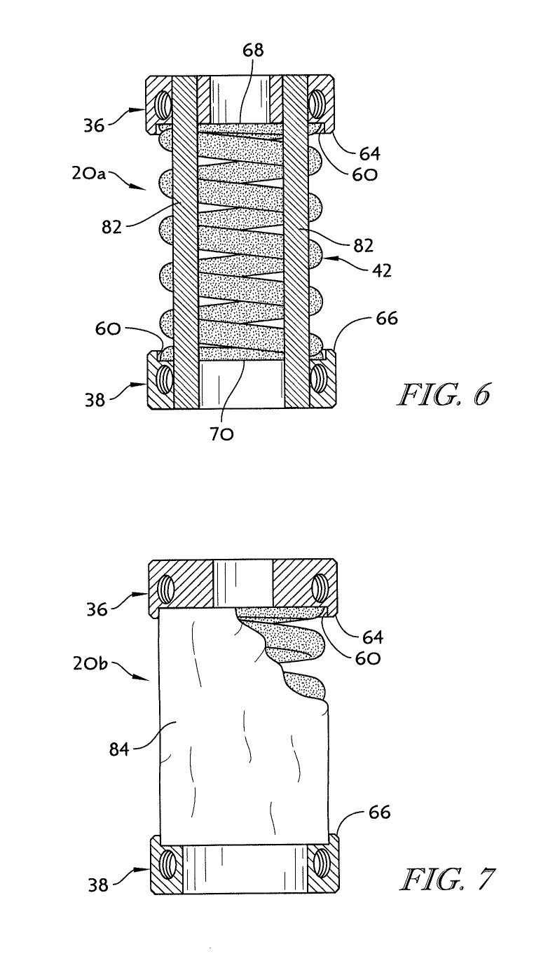

As noted above, the attachment of the resiliant biasing member 42 relative to the collars 36, 38 is intended to be broadly interpreted and always possible relative to the disclosure provided herein. The coil ends 68, 70 of the resiliant biasing member 42 can be welded to the contact surfaces 40 within the corresponding ledge 60 providing weld sillets 34 between the contact surface 40 and the coil ends 68, 70. Alternatively, the coil ends 68, 70 of the resiliant biasing member 42 may be welded to the corresponding ends 64, 66, respectively, of the collars 36, 38. As another alternative, other means such as strapping, interference fit, or other ways of attaching the resiliant biasing member 42 to the collars 36, 38 are included within the scope of the present disclosure. In an exemplary embodiment, the annular ledge 60 can be formed with an inside diameter 72, 74 which is approximately equal to and, perhaps, slightly smaller than the corresponding outside diameter 76, 78, respectively, of the coil ends 68, 70 of the resiliant biasing member 42. In this regard, a tight interference fit can be formed between the ledge 60 and the coil ends 68, 70 either eliminating the need for welding, or complementing a weld 34 connection in addition to the interference fit. Additionally as described and illustrated in FIGS. 6 and 7, a strap 82, sheath 84, or other mechanical attachment can be connected between the collars 36, 38 to retain the resiliant biasing member 42 therebetween in a slightly compressed manner so that the resiliant biasing member 42 is retained with the collars 36, 38 as an assembly. A version of the straps 82 can be seen in FIG. 6 as an alternate embodiment 20a, and a version of the sheath 84 can be seen in FIG. 7 as another alternate embodiment 20b. Typically, an apparatus such as shown in FIG. 1 would not include a variety of means or structures for holding the parts hold-down assembly 20 together, but would incorporate one primary type of retaining the parts hold-down assembly 20.

The addition of the annular ledge 60 and the attachment of the coil ends 68, 70 of the resiliant biasing member 42 in the annular ledge 60 improve the operation of the mechanism and prevent problems and damage to the mechanism as well as parts. One of the problems with the previous hold-down assemblies is that when the welds attaching the coil ends 68 70 to the collars 36, 38 broke or started to fail, the resiliant biasing member 42 might shift or become misaligned relative to the overall axial alignment of the assembly. As an example, if one or multiple welds 34, but not all welds 34, in the hold-down assembly 20 failed, the hold-down assembly 20 might be misaligned relative to the part 22. This could cause jamming of the part 22 or breakage of the hold-down assembly 20. Furthermore, if the resiliant biasing member 42 is not aligned with the part 22, it may not exert the right amount or direction of pressure onto the part 22, causing the part 22 to be susceptible to shiftage upon application of the peening process.

Furthermore, if the entire set of welds 34 failed so that the collars 36, 38, may no longer attach to the resiliant biasing member 42. If this occurred mid-processing, the lower collar 38 and the masking portion 46 might be missing during the operation, resulting in peening of the end surface 50 of the part 22. These failures are problematic since the automated nature of the apparatus might result in detection of the failure of the welds 34 and hold-down assembly 20 only after several parts 22 have been processed. Also, failure of the system causes the apparatus to be taken down for repair incurring additional costs, process slow down, and the cost of the repair personnel, parts and other associated costs.

In contrast, even if a weld 34 breaks on the present embodiment as disclosed herein the coil ends 68, 70 of the resiliant biasing member 42 will still be positively captured by the annular ledge 60 in the corresponding collars 36, 38. Additionally, if the parts 22 are manufactured with sufficiently tight tolerances to provide the interference fit, failure of the welds 34 may still not cause misalignment of disengagement of the parts 22 in the parts hold-down assembly 20. As a result, even weld 34 failures may not result in complete failure of the system.

Weld 34 failures can still be noticed as a result of periodic inspection and maintenance as carried out on previous hold-down assemblies. However, until the weld 34 failure or other component failure is detected through such inspection, the assembly can still operate and not incur down time, damage to components and other associated costs. It should be noted that the parts 22 being peened should not be damaged. As an example, failure to properly mask the end surface 50 of part 22 as a result of a failure of the hold-down assembly 20 might result in scrapping a part 22. This is important to not occur since the parts 22 are typically being prepared in a just in time process mode and there is little if any room to tolerate damage to parts. As a result, the peening process including the part hold-down assembly 20 must be constructed to prevent any damage to any part 22 during the processing steps.

By way of review, a part 22 is attached or fixtured on the support 24 of the processing assembly 10, as disclosed herein and in U.S. Pat. No. 5,272,897. The part 22 is then captured between the support 24 and the lower collar 38 of the parts hold-down assembly 20, with the part 22 being optionally captured by the upper masking portion 46 attached to the lower collar 38. The part hold-down assembly 20 includes the collars 36, 38 retaining the resiliant biasing member 42 therebetween. The resiliant biasing member 42 provides a degree of compressive engagement to retain the part 22 on the support 24 and may be in the form of a coil spring 42. The part hold-down assembly 20 carried on the shaft 32 is raised and lowered during the automated processing steps making axial alignment of the part hold-down assembly 20 relative to the part 22 carried on the support 24 an important processing step. As the part hold-down assembly 20 is axially advanced downwardly toward the part 22, the corresponding surface 52 of the masking portion 46 may engage the corresponding surface 50 of the part 22 during the processing. The processing may include, but is not limited to, peening operations. For example, the part 22 can be rotated on the lower support 24 during the processing step, during which a group of peening nozzles 54 spray peening material at the part 22 to provide processing characteristics on the part 22 surface to, in part, improve wear and durability as well as other characteristics.

The part hold-down assembly 20 includes the two collars 36, 38 securing the resiliant biasing member 42 therebetween. As noted above, the collars 36, 38 include the annular ledges 60 which engage the corresponding coil ends 68, 70 of the resiliant biasing member 42. As noted, the coil ends 68, 70 can be welded with a weld 34 after they are engaged in the annular ledge 60. Additionally, interference fit may be achieved by the dimensional characteristics of the coil ends 68, 70 and the corresponding annual ledges 60. Alternative embodiments of attachment to retain the resiliant biasing member 42 relative to the collars 36, 38 can be obtained.

In the event of a breakage of a weld 34, the part hold-down assembly 20 can still retain the collars 36, 38 relative to the resiliant biasing member 42 to facilitate ongoing processing operations of the part 22 in the overall apparatus. This prevents the resiliant biasing member 42 from “walking” or slipping off of the collars 36, 38.

The foregoing terms as well as other terms should be broadly interpreted throughout this application to include all known as well as all hereafter discovered versions, equivalents, variations and other forms of the abovementioned terms as well as other terms. The present disclosure is intended to be broadly interpreted and not limited.

While the present disclosure describes various exemplary embodiments, the disclosure is not so limited. To the contrary, the disclosure is intended to cover various modifications, uses, adaptations, and equivalent arrangements based on the principles disclosed. Further, this application is intended to cover such departures from the present disclosure as come within at least the known or customary practice within the art to which it pertains. It is envisioned that those skilled in the art may devise various modifications and equivalent structures and functions without departing from the spirit and scope of the disclosure as recited in the following claims. The scope of the following claims is to be accorded the broadest interpretation so as to encompass all such modifications and equivalent structures and functions.

1. A part hold-down assembly for retaining a part, comprising:
an upper collar having a first end, the first end having an annular ledge;
a lower collar having a second end, the second end having a second annular ledge; and
a resiliant biasing member retained between the upper collar and the lower collar, wherein the resiliant biasing member includes a first end and a second end, the first end configured to engage with the annular ledge of the upper collar and the second end configure to engage with the second annular ledge of the lower collar.

2. The part hold-down assembly of claim 1, wherein the first end and second end of the resiliant biasing member include a flattened portion.

3. The part hold-down assembly of claim 2, wherein the flattened portion of the first coil end is configured to engage with a first contact surface of the upper collar, and the flattened portion of the second coil end is configured to engage with a second contact surface of the lower collar.

4. The part hold-down assembly of claim 3, wherein the first contact surface is radially inward of the annular ledge of the upper collar and the second contact surface is radially inward of the annular ledge of the lower collar.

5. The part hold-down assembly of claim 1, wherein the first end is configured to have a diameter equal to or greater than a diameter of the annular ledge of the upper collar.

6. The part hold-down assembly of claim 5, wherein the second end is configured to have a diameter equal to or greater than a diameter of the annular ledge of the lower collar.

7. The part hold-down assembly of claim 1, wherein the lower collar is configured to engage with the part.

8. The part hold-down assembly of claim 1, wherein the part hold-down assembly also includes a masking portion coupled to the lower collar to engage with the part.

9. The part hold-down assembly of claim 8, wherein the masking portion is configured to be opposite from and extend away from the annular ledge of the lower collar.

10. The part hold-down assembly of claim 8, wherein the masking portion is configured to abut against a surface of the part.

11. The part hold-down assembly of claim 8, wherein the part hold-down assembly also includes an adjustment insert attached to the lower collar to extend the lower collar.

12. The part hold-down assembly of claim 11, wherein the adjustment insert is coupled between the masking portion and the lower collar.

13. The part hold-down assembly of claim 1, wherein the biasing member is metallic and the first end is welded to the upper collar and the second end is welded to the lower collar.

14. The part hold-down assembly of claim 1, wherein the biasing member is retained between the upper collar and lower collar by a strap.

15. The part hold-down assembly of claim 1, wherein the biasing member is retained between the upper collar and lower collar by a sheath surrounding the entire part hold-down assembly.

16. The part hold-down assembly of claim 1, wherein the biasing member is in the form of a coil spring.

17. An apparatus for processing parts, comprising:
a part-hold down assembly for retaining the part in the apparatus during processing;
an upper shaft configured to retain the part hold-down assembly in the apparatus;
a support configured to retain the part in the apparatus; and
wherein the part hold-down assembly includes an upper collar, a lower collar, and a resiliant biasing member retained therebetween, the upper and the lower collars include an annular ledge formed in corresponding surfaces to retain a portion of a corresponding end of the resiliant biasing member therein, the corresponding ends of the resiliant biasing member being attached to the corresponding ends of the upper and lower collars with the ends of the resiliant biasing member being retained in the corresponding annular ledges.

18. The apparatus of claim 17, wherein the resiliant biasing member include a first coil end and a second coil end.

19. The apparatus of claim 18, wherein the first coil end and the second coil end of the coil resiliant biasing member include a flattened portion.

20. The apparatus of claim 19, wherein the flattened portion of the first coil end is configured to engage with a first contact surface of the upper collar, and the flattened portion of the second coil end is configured to engage with a second contact surface of the lower collar.

21. The apparatus of claim 17, wherein the first coil end is configured to have a diameter equal to or greater than a diameter of the annular ledge of the upper collar.

22. The apparatus of claim 21, wherein the second coil end is configured to have a diameter equal to or greater than a diameter of the annular ledge of the lower collar.

23. The apparatus of claim 17, wherein the part hold-down assembly also includes a masking portion coupled to the lower collar to engage with the part.

24. The apparatus of claim 23, wherein the masking portion is configured to be opposite from and extend away from the annular ledge of the lower collar.

25. The apparatus of claim 23, wherein the masking portion is configured to abut against a surface of the part.

26. The apparatus of claim 23, wherein the part hold-down assembly also includes an adjustment insert attached to the lower collar to extend the lower collar.

27. The apparatus of claim 26, wherein the adjustment insert is coupled between the masking portion and the lower collar.

28. The apparatus of claim 23, wherein the lower collar includes one or more sets of screws to attach the lower collar with the masking portion.

29. The apparatus of claim 17, wherein the first coil end is welded to the upper collar and the second coil end is welded to the lower collar.

30. The apparatus of claim 17, wherein the upper collar includes one or more sets of screws that permit the upper collar to be coupled to the upper shaft.

31. The apparatus of claim 17, wherein the biasing member is in the form of a coil spring.
